(19) United States
(12) Patent Application Publication
(10) Pub. No.: US 2018/0150663 A1
(43) Pub. Date: May 31, 2018

(54) CARD READER AND METHOD OF CONTROLLING CARD READER

(71) Applicant: NIDEC SANKYO CORPORATION, Suwa-gun (JP)

(72) Inventor: Fumihiko AKAHANE, Suwa-gun (JP)

(21) Appl. No.: 15/825,908

(22) Filed: Nov. 29, 2017

(30) Foreign Application Priority Data
Nov. 29, 2016 (JP) 2016-231582

(51) Int. Cl. G06K 7/10

(52) U.S. Cl. CPC G06K 7/10366

(57) ABSTRACT

A card reader for connecting a plurality of types of devices detachably may include a connection detection unit configured to check a connector to which a socket is connected among connectors of the plurality of types of devices; a device discrimination unit configured to check information stored in association with the connector checked by the connection detection unit and to set a security level of an own apparatus; and a data-processing unit configured to record or reproduce data in a card corresponding to the security level of the own apparatus that is set by the device discrimination unit.

### CROSS REFERENCE TO RELATED APPLICATION

The present invention claims priority under 35 U.S.C. § 119 to Japanese Application No. 2016-231582 filed Nov. 29, 2016, the entire content of which is incorporated herein by reference.

### FIELD OF THE INVENTION

At least an embodiment of the present invention particularly relates to a card reader and a method of controlling the card reader.

### BACKGROUND

Conventionally, there has been a card reader that reads recorded magnetic information from and writes new magnetic information into a magnetic stripe by bringing a normal magnetic head (hereinafter referred to as “normal magnetic head) in sliding contact with the magnetic stripe formed on a card-shaped medium (hereinafter simply referred to as “card”).

In industries where this card reader is used, conventionally, so-called skimming has been a problem by which a criminal attaches a signal line to a magnetic head or the like and illegally acquires magnetic information recorded in the card. Therefore, an encryption magnetic head that can prevent this skimming has been proposed (for example, refer to Japanese Patent Laid-Open No. 2011-40140). In the encryption magnetic head disclosed in Japanese Patent Laid-Open No. 2011-40140, a terminal of a magnetic head is connected to one end of a flexible cable inside a head case of the magnetic head. The other end of the flexible cable is connected to one surface of a substrate inside the head case. A demodulation IC that demodulates an output signal from the terminal of the magnetic head is mounted on one surface of the substrate, whereas a central processing unit (CPU) that encrypts a demodulated signal from the demodulation IC is mounted on the other surface of the substrate. The substrate is fixed to the head case such that the demodulation IC is disposed inside a case body and that the CPU is disposed outside the case body.

Thus, even for a card reader including the encryption magnetic head that can prevent skimming, there is desire to arbitrarily replace the encryption magnetic head with the normal magnetic head depending on a customer environment (detachable). Thus, allowing the encryption magnetic head to be replaced with the normal magnetic head eliminates the need for exchanging the entire card reader and improves convenience.

Meanwhile, a technique to prevent removal of a removable device connected to a computer is disclosed (for example, refer to Japanese Patent Laid-Open No. 2005-346172). According to the technique of Japanese Patent Laid-Open No. 2005-346172, information regarding a removable device of which removal is to be prevented is registered with a database as theft prevention of an external device. Only in a case where information regarding a removable device for which a removal request or removal act is made has been registered with the database, validity of the removal request or the removal act is verified.

### SUMMARY

However, the technique disclosed in Japanese Patent Laid-Open No. 2005-346172 is a technique to issue a warning when the removable device is removed. There is a problem that no warning is issued even if a removable device with a low security level is replaced with a removable device with a high security level and then the removable device with a low security level is connected again. Therefore, the technique of Japanese Patent Laid-Open No. 2005-346172 makes it possible, for example, in a card reader, to replace the encryption magnetic head that can prevent skimming with the normal magnetic head. As a result, the conventional technique has a problem that skimming and the like cannot be prevented, and that security cannot be maintained.

Therefore, at least an embodiment of the present invention has been made in view of such a circumstance, and at least an embodiment of the present invention provides a card reader that can maintain security even if replacement is made with a device with a different security level. Also, at least an embodiment of the present invention has been made in view of such a circumstance, and at least an embodiment of the present invention provides a method of controlling the card reader that can maintain security even if replacement is made with a device with a different security level.

A card reader of at least an embodiment of the present invention is a card reader for connecting a plurality of types of devices detachably. The card reader includes: a connection detection unit configured to check a connector to which a socket is connected among connectors of the plurality of types of devices; a device discrimination unit configured to check information stored in association with the connector checked by the connection detection unit and to set a security level of an own apparatus; and a data-processing unit configured to record or reproduce data in a card corresponding to the security level of the own apparatus that is set by the device discrimination unit. Such a configuration allows security to be maintained even if the card reader allows replacement with a device with a different security level.

In the card reader of at least an embodiment of the present invention, the device discrimination unit: checks the information regarding the security level that is set corresponding to the device detected by the connection detection unit; sets the security level of the own apparatus during operation high in a case where the security level corresponding to the checked device is higher than or equal to the security level corresponding to the device connected before; and prohibits the own apparatus from operating unless an identification operation is performed in a case where the security level corresponding to the checked device is lower than the security level corresponding to the device connected before. Such a configuration allows flexible device change while maintaining security.

In the card reader of at least an embodiment of the present invention, the device discrimination unit: acquires permission to operate from a user as the identification operation; and sets the security level of the own apparatus during operation high in a case where the permission to operate is acquired. Such a configuration allows flexible device change while maintaining security.

In the card reader of at least an embodiment of the present invention, the plurality of types of devices includes a normal magnetic head, an encryption magnetic head, an IC contact block, and a noncontact type communication antenna. The connector includes a first connector to which one of the socket for the normal magnetic head and the socket for the encryption magnetic head is connectable, a second connector to which the IC contact block is connectable, and a third connector to which the noncontact type communication antenna is connectable. Such a configuration allows a configuration including another device to be easily obtained while exchanging the normal magnetic head or encryption magnetic head.

In the card reader of at least an embodiment of the present invention, the security levels corresponding to the encryption magnetic head, the IC contact block, and the noncontact type communication antenna are higher than the security level corresponding to the normal magnetic head. Such a configuration allows the card reader, when a device with a high security level is connected, to prevent customer's magnetic data from being skimmed by a device with a low security level.

A method of controlling a card reader of at least an embodiment of the present invention is a method of controlling a card reader to be executed by the card reader for connecting a plurality of types of devices detachably. The method includes: checking a connector to which a socket is connected among connectors of the plurality of types of devices; and checking information stored in association with the checked connector and setting a security level of an own apparatus. Such a configuration allows security to be maintained even if the card reader allows replacement with a device with a different security level.

At least an embodiment of the present invention can provide a card reader that can maintain the security level even when replacement is made with a device with a different security level, by comparing, when a device is detected, a security level of the device with a security level of a device connected before, and by performing control to allow the detected device to operate when the security level is higher or identical, and to prohibit the detected device from operating when the security level is lower.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically illustrating a configuration of a card reader according to an embodiment of the present invention;

FIG. 2A is a plan view of a card 2, and FIG. 2B is a cross-sectional view taken along the line I-I of FIG. 2A;

FIG. 3 is a block diagram illustrating a control configuration of the card reader according to the embodiment of the present invention;

FIGS. 4A-4C are conceptual diagrams illustrating an example of information stored in a storage unit illustrated in FIG. 3;

FIG. 5 is a flowchart of a device connection setting process according to the embodiment of the present invention; and

FIGS. 6A-6C are conceptual diagrams of an operation example of the card reader according to the embodiment of the present invention.

### DETAILED DESCRIPTION

An embodiment of the present invention will be described below with reference to the drawings.

[Schematic Configuration of Card Reader 1]

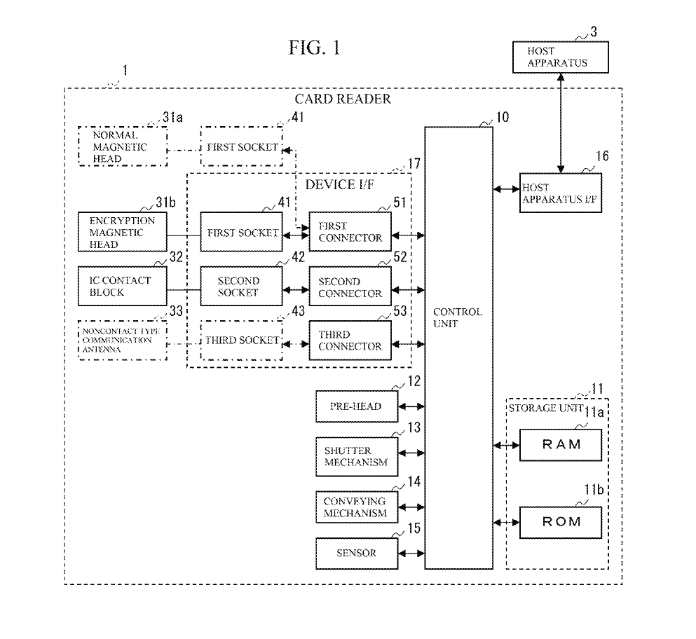

FIG. 1 is a block diagram illustrating a schematic configuration of a card reader 1 according to an embodiment of the present invention.

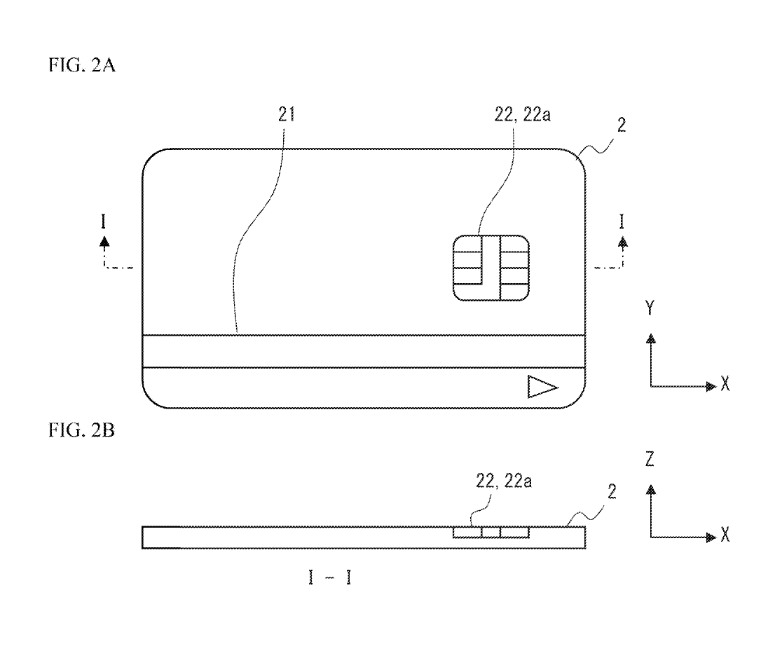

FIG. 2A is a plan view of a card 2.

FIG. 2B is a cross-sectional view taken along the line I-I of FIG. 2A.

The card reader 1 of the present embodiment is a card reader that detachably connects a plurality of types of devices. The card reader 1 is an apparatus that reads data recorded in the card 2 and records data into the card 2. The card reader 1 is mounted and used on a predetermined host apparatus 3, such as an automated teller machine (ATM), for example.

The card 2 is, for example, a card made of vinyl chloride with a thickness of about 0.7 to 0.8 mm. As illustrated in FIG. 2, an IC chip 22 is incorporated on a front face of the card 2, and for example, a terminal part 22a including eight external connection terminals is formed. Bringing this terminal part 22a into contact with an IC contact block 32 of the card reader 1 to be described later will enable data to be read from the IC chip 22. A magnetic stripe 21 in which magnetic data is recorded is formed on a rear face of the card 2. That is, the card 2 has both a function as a magnetic card and a function as a contact type IC card.

(Card Reader)

The card reader 1 mainly includes a control unit 10, a storage unit 11, a pre-head 12, a shutter mechanism 13, a conveying mechanism 14, sensors 15, a host apparatus I/F 16, and a device I/F 17. The card reader 1 is configured to electrically connect a plurality of types devices replaceably to the device I/F 17.

The control unit 10 is, for example, a CPU having a calculation function to control the entire card reader 1. The control unit 10 executes a program stored in a read-only memory (ROM) 11b by using a random-access memory (RAM) 11a as a work area, and controls an operation of each unit of the card reader 1. For example, the control unit 10 also controls operations such as reading and writing of a magnetic signal from and into the card 2 by a magnetic head, writing from the IC contact block 32, information acquisition from various sensors 15, conveyance of the card 2 by a drive unit of the conveying mechanism 14, and drive of the shutter mechanism 13. The control unit 10 also exchanges signals with each device of a device group connected to the device I/F 17, and communicates with the host apparatus 3.

The storage unit 11 is a nontemporary recording medium including the ROM 11b and the RAM 11a.

The RAM 11a is used as a working area or the like when the control unit 10 executes a program stored in the ROM 11b. In a case where the RAM 11a is a dynamic random-access memory (DRAM), the RAM 11a is a rewritable volatile memory. Note that the RAM 11a may include a nonvolatile memory such as a battery backup static random-access memory (SRAM).

The ROM 11b is a nonvolatile memory that stores work data, a control program, and other data necessary for various operations of the card reader 1. The ROM 11b may also be, for example, a rewritable, nontemporary recording medium such as an electrically erasable programmable ROM (EEPROM) 11b and a flash memory. The control unit 10 performs processing based on the program and data stored in the ROM 11b to control each unit of the apparatus.

The pre-head 12 is a magnetic head or the like to be used only for detecting that the card 2 is inserted into the card reader 1. The pre-head 12 is disposed inside a card insertion part that constitutes a front-end side portion of the card reader 1.

The shutter mechanism 13 is a mechanism that drives a shutter member or the like that prevents outside dust particles and foreign substances from going in. The shutter mechanism 13 is disposed, for example, in the card insertion part of the card reader 1. The shutter mechanism 13 moves, by power of a solenoid (not illustrated), the shutter member between a close position to block a card conveying passage (not illustrated) and an open position to open the card conveying passage.

The conveying mechanism 14 is a mechanism that conveys the card 2 inside the card conveying passage of the card reader 1. The conveying mechanism 14 causes, for example, an unillustrated drive roller to be rotated by power of the drive unit such as a coupled motor. The conveying mechanism 14 then conveys the card 2 between the drive roller and an oppositely disposed pad roller while being urged toward the drive roller.

The sensors 15 detect a position of the card 2 conveyed inside the card reader 1. The sensors 15 are, for example, optical sensors including a light-emitting element (photodiode) and a light-receiving element (photosensor 15). Disposing a plurality of such sensors 15 with positions changed inside the conveying passage enables detection of the position of the card 2 in the card conveying passage.

The host apparatus I/F 16 is an interface to perform various communications with the host apparatuses 3. The host apparatus I/F 16 is, for example, an RS-232C interface and a universal serial bus (USB) interface.

The device I/F 17 is an interface that can connect a plurality of types of devices to a plurality of connectors. In the example of the present embodiment, the device I/F 17 includes a first connector 51, a second connector 52, and a third connector 53, and connects devices via a first socket 41, a second socket 42, and a third socket 43, respectively.

The first connector 51 is a connector that electrically connects the magnetic head that is in sliding contact with the magnetic stripe 21 on the card 2 and records or reproduce magnetic data. In the present embodiment, as this magnetic head, one of a normal magnetic head 31a and an encryption magnetic head 31b described below can be connected via the similar first socket 41. The second connector 52 is a connector that electrically connects, via the second socket 42, the IC contact block 32 that abuts the terminal part 22a disposed on the card 2 and records or reproduces data. The third connector 53 is a connector that electrically connects, via the third socket 43, a noncontact type communication antenna that records or reproduces information by electromagnetic induction with a coil buried in the card 2.

The example of the present embodiment will describe a configuration in which, in the device I/F 17, as a device group, a device A or device B described below can be electrically connected to the first connector 51 via the first socket 41, a device C can be electrically connected to the second connector 52 via the second socket 42, and a device D can be electrically connected to the third connector 53 via the third socket 43.

In the present embodiment, the device A is the normal magnetic head 31a that can be connected to the first socket 41. The normal magnetic head 31a, which is in sliding contact with the magnetic stripe 21 formed on the card 2, reads recorded magnetic data from or writes new magnetic data into the magnetic stripe 21. As described above, the normal magnetic head 31a can be electrically connected to the first connector 51 via the first socket 41 instead of the encryption magnetic head 31b described below (replacement).

The device B is the encryption magnetic head 31b. The encryption magnetic head 31b generates an encryption signal that is encrypted to allow skimming prevention. The encryption magnetic head 31b includes, for example, a magnetic head unit, an electronic component for demodulation (demodulation IC), and an electronic component for encryption (encryption CPU). In a similar manner to the normal magnetic head 31a, the magnetic head unit, which is in sliding contact with the magnetic stripe 21 formed on the card 2, reads recorded magnetic data from or writes new magnetic data into the magnetic stripe 21. The demodulation IC is an electronic component for demodulation that demodulates an analog output signal that is output from the magnetic head unit and generates a digital demodulation signal. The encryption CPU has a function to encrypt the demodulation signal and to generate the encryption signal by using a predetermined encryption function and key data. That is, the encryption CPU of the present embodiment is an electronic component for encryption that encrypts the demodulation signal and generates the encryption signal. In other words, since the magnetic head unit is connected to the demodulation IC in the encryption magnetic head 31b, the magnetic data (signal) that is output from the magnetic head is demodulated by the demodulation IC and becomes the digital demodulation signal, and this demodulation signal is encrypted by the encryption CPU and becomes the encryption signal. That is, in the present embodiment, the magnetic data (signal) that is output from the encryption magnetic head 31b is encrypted and output to the card reader 1 as the encryption signal. Note that structures of these encryption magnetic head 31b and the normal magnetic head 31a are disclosed in Japanese Patent Laid-Open No. 2011-40140 and Japanese Patent Laid-Open No. 2013-4053, and thus detailed description thereof will be omitted.

The device C is the IC contact block 32. The IC contact block 32 comes in contact with the terminal part 22a that is a contact type input output terminal of the IC chip 22 formed in the card 2, and performs communication such as reading or writing of IC information with the card 2. More specifically, the IC contact block 32 includes an IC contact spring that comes in contact with the terminal part 22a of the card 2. The IC contact block 32 is movable, by power of a solenoid (not illustrated), between a contact position where the IC contact block 32 approaches the card conveying passage and the IC contact spring comes in in contact with the terminal part 22a of the card 2, and a retreat position where the IC contact block 32 retreats from the card conveying passage.

The device D is a noncontact type communication antenna 33. In a case where the noncontact type communication antenna 33 is connected to the card reader 1, a secure application module (SAM) that authenticates the card is connected to an unillustrated SAM socket. Although not illustrated, an IC chip and an antenna coil are buried in the card 2, and based on electromagnetic interaction via the antenna coil, information is recorded or reproduced. Note that as illustrated, the noncontact type communication antenna 33 and the third socket 43 are not connected in the present embodiment.

Here, the present embodiment describes an example in which the encryption magnetic head 31b of the device B is electrically connected to the first connector 51 via the first socket 41, and the IC contact block 32 of the device C is electrically connected to the second connector 52 via the second socket 42. Although the noncontact type communication antenna 33 of the device D can be electrically connected to the third connector 53 via the third socket 43, as described above, the present embodiment describes an example in which the noncontact type communication antenna 33 is not connected.

Note that in addition to the above-described units, the card reader 1 of the present embodiment includes a display unit, an input unit, and a warning unit.

The display unit is, for example, display means including a liquid crystal panel and a liquid crystal drive circuit. The display unit displays images in response to an instruction transmitted from the control unit 10 of the card reader 1. Note that the display unit may be configured to also function as an input unit by having a touch-panel function. The user uses the display unit when entering a password to be described later.

The input unit is input means including an operator such as a plurality of keys, for example. When the user operates the input unit, the input unit will supply a signal indicating the user's operation to the card reader 1, and the control unit 10 will perform processing in response to this signal. The user uses the input unit when entering a password to be described later.

The warning unit is, for example, an alarm buzzer, a siren, and an LED. The warning unit makes a notification, for example, when a device of a high security level (H) is replaced with a device with a low security level (L), by causing the alarm buzzer or siren to sound in response to the instruction signal from the card reader 1, or turning on or blinking the LED.

These display unit, input unit, and warning unit are not limited to an example of being included in the card reader 1, and may be installed in the host apparatus.

[Control Configuration of Card Reader 1]

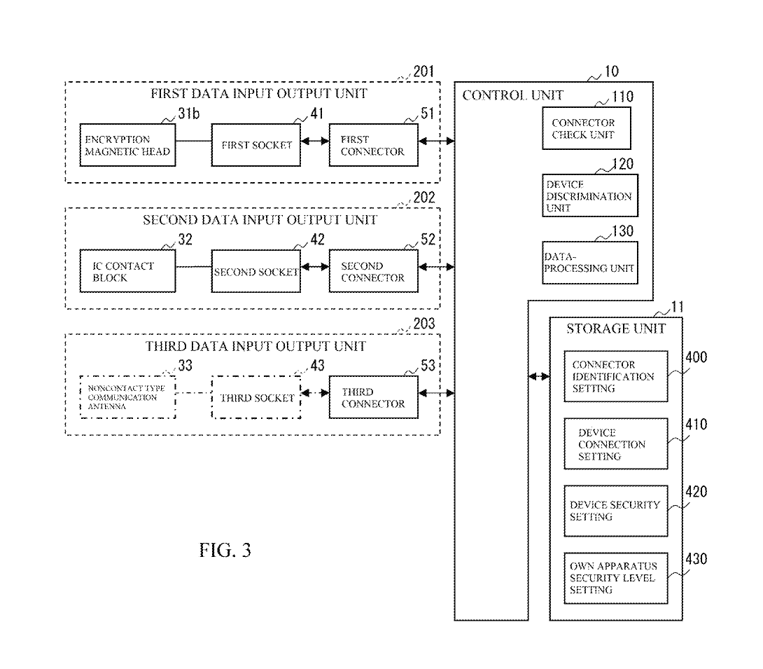

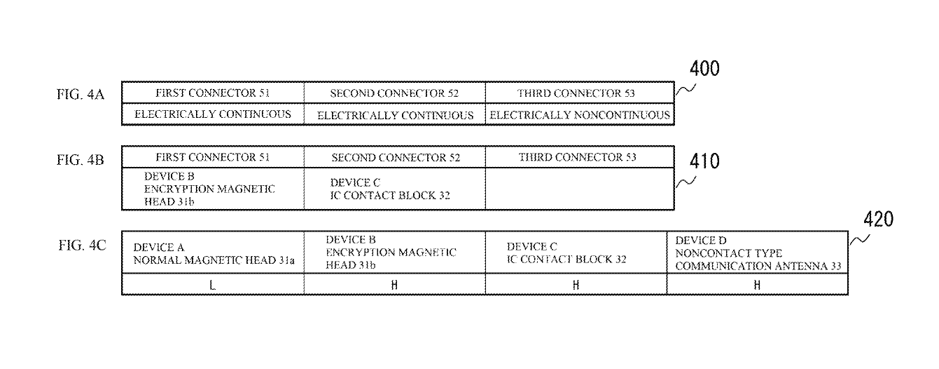

FIG. 3 is a block diagram illustrating a control configuration related to the control unit 10 of the card reader 1. FIGS. 4A-4C are diagrams illustrating an example of information stored in the storage unit 11. In the card reader 1, a first data input output unit 201, a second data input output unit 202, a third data input output unit 203, and the storage unit 11 are connected to the control unit 10.

The first data input output unit 201 of the present embodiment is a magnetic data input output unit including the encryption magnetic head 31b, the first socket 41, and the first connector 51. Here, since the magnetic head unit is connected to the demodulation IC in the encryption magnetic head 31b as described above, magnetic data (signal) that is output from the magnetic head unit is demodulated by the demodulation IC and becomes a digital demodulation signal, and then this demodulation signal is encrypted by the encryption CPU and becomes an encryption signal. That is, in the present embodiment, the magnetic data (signal) that is output from the magnetic head unit of the encryption magnetic head 31b is encrypted and output to the control unit 10 as the encryption signal. Moreover, magnetic data (signal) is input from the control unit 10 into the magnetic head.

Note that instead of the encryption magnetic head 31b, the normal magnetic head 31a may be connected to the first data input output unit 201 for replacement. In this case, the normal magnetic head 31a comes in sliding contact with the magnetic stripe 21 on the card and outputs magnetic data to the control unit 10. Moreover, magnetic data (signal) is input from the control unit 10 into the normal magnetic head 31a.

In the present embodiment, the second data input output unit 202 includes the IC contact block 32, the second socket 42, and the second connector 52. In the second data input output unit 202, the IC contact block 32 abuts the terminal part 22a disposed on the card 2 and outputs data (signal) to the control unit 10. Moreover, data (signal) from the control unit 10 is input into the IC contact block 32.

In the present embodiment, the third data input output unit 203 includes the third connector 53. Nothing is connected to the third data input output unit 203 in the present embodiment. However, in the third data input output unit 203, when the noncontact type communication antenna 33 is electrically connected via the third socket 43, data (signal) that is output by electromagnetic induction between the noncontact type communication antenna 33 and a coil buried in the card 2 is output to the control unit 10. In this case, data (signal) from the control unit 10 is input into the noncontact type communication antenna 33.

(Configuration of Control Unit 10 and Storage Unit 11)

The control unit 10 includes a connector check unit 110, a device discrimination unit 120, and a data-processing unit 130. The storage unit 11 stores a connector identification setting 400, a device connection setting 410, a device security setting 420, and an own apparatus security level setting 430 in a nonvolatile memory of the RAM 11a or ROM 11b.

The connector check unit 110 is a connection detection unit that checks a connector to which a socket is connected among a plurality of types of connectors. In the present embodiment, the connector check unit 110 determines and checks devices connected to the device I/F 17 by inspecting continuity between the first connector 51 and the first socket 41, between the second connector 52 and the second socket 42, and between the third connector 53 and the third socket 43. The connector check unit 110 stores information indicating the checked connectors in the storage unit 11 as the connector identification setting 400. FIG. 4A is a diagram illustrating an example of information about the connector identification setting 400 stored in the storage unit 11. The connector check unit 110 stores flags indicating presence of connection of each device to each connector in association with each connector. In the example of FIG. 4A, the first socket 41 is connected to the first connector 51, and the second socket 42 is connected to the second connector 52.

The device discrimination unit 120 checks information stored in association with the connectors checked by the connector check unit 110. The device discrimination unit 120 stores information indicating the device connected to each connector in the storage unit 11 as the device connection setting 410. The device discrimination unit 120 sets the device connection setting 410 at a time of connector check made by the connector check unit 110, shutdown (end) of the card reader 1, or before device exchange. FIG. 4B is a diagram illustrating an example of the device connection setting 410 stored in the storage unit 11.

Also, with reference to the device security setting 420 stored in the storage unit 11, the device discrimination unit 120 acquires information regarding a security level of each device, and sets the information in the own apparatus security level setting 430. FIG. 4C illustrates an example of the device security setting 420.

More specifically, in a case where the security level corresponding to the checked device is higher than or equal to the security level corresponding to a device connected before, the device discrimination unit 120 sets the security level of the own apparatus during operation high. Alternatively, in a case where the security level corresponding to the checked device is lower than the security level corresponding to the device connected before, the device discrimination unit 120 performs control to prohibit the own apparatus from operating unless an identification operation is performed. As the identification operation, the device discrimination unit 120 acquires permission to operate from a user, and if the permission to operate is acquired, the device discrimination unit 120 sets the security level of the own apparatus during operation high.

In accordance with the own apparatus security level setting 430 that is set by the device discrimination unit 120, the data-processing unit 130 performs a process of recording or reproducing data in the card 2. More specifically, the data-processing unit 130 includes a magnetic data-processing unit 130 that brings the magnetic head in sliding contact with the magnetic stripe 21 on the card 2 and records or reproduces magnetic data, a contact type data-processing unit 130 that causes the IC contact to abut the IC terminal disposed on the card and records or reproduces data, and a noncontact type data-processing unit 130 that records or reproduces information by electromagnetic induction between the coil buried in the card and the noncontact type communication antenna.

By developing in the RAM 11a and executing the control program stored in the ROM 11b of the storage unit 11, the control unit 10 can cause the control program to function as the connector check unit 110, the device discrimination unit 120, and the data-processing unit 130. Note that either of, arbitrary combination of, or all of the connector check unit 110, the device discrimination unit 120, and the data-processing unit 130 can include dedicated communication circuitry.

Here, the security level of the present embodiment will be described. The security level indicates, for example, a value corresponding to tolerance (security) to fraud (criminal) on each device. In the example of the present embodiment, the security level corresponding to the device A is set at “L” (low), whereas the security level corresponding to other devices B to D is set at “H” (high). In other words, the security level corresponding to the normal magnetic head 31a of the device A is “L” (low), whereas the security level corresponding to the encryption magnetic head 31b of the device B is “H” (high). Similarly, the security level corresponding to the IC contact block 32 of the device C is “H.” The IC contact block 32 allows the IC chip 22 of the card 2 to perform encrypted communication with the control unit 10. Therefore, the IC contact block 32 has a high defense level against various malicious acts (hereinafter referred to as “criminal”). That is, compared with the normal magnetic head 31a, the security level is “H.” Similarly, the security level of the noncontact type communication antenna 33 of the device D is “H”, for a similar reason to the IC contact block 32. That is, in the present embodiment, in the own apparatus security level setting 430, the security levels corresponding to the encryption magnetic head 31b of the device B, the IC contact block 32 of the device C, and the noncontact type communication antenna 33 of the device D are higher than the security level corresponding to the normal magnetic head 31a of the device A.

In summary, the connector identification setting 400 stored in the storage unit 11 is, among a plurality of types of device connectors, information indicating a connector confirmed by the connector check unit 110 that a socket is connected thereto. The device connection setting 410 is information indicating a device connected to each connector. The device security setting 420 is setting of the security level that is set in advance for each device A to device D. That is, the device security setting 420 is information regarding the security level that is set corresponding to the device detected by the connector check unit 110. The own apparatus security level setting 430 is a setting of the security level of the own apparatus. Note that as will be described later, the own apparatus security level setting 430 may be set in the volatile memory of the RAM 11a of the storage unit 11 every time the connectors are checked.

[Device Connection Setting Process]

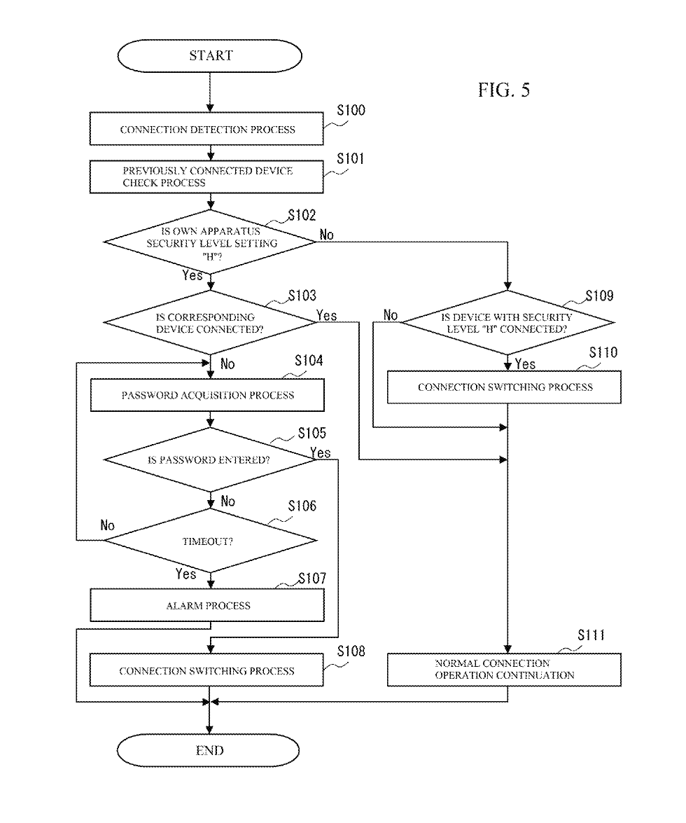

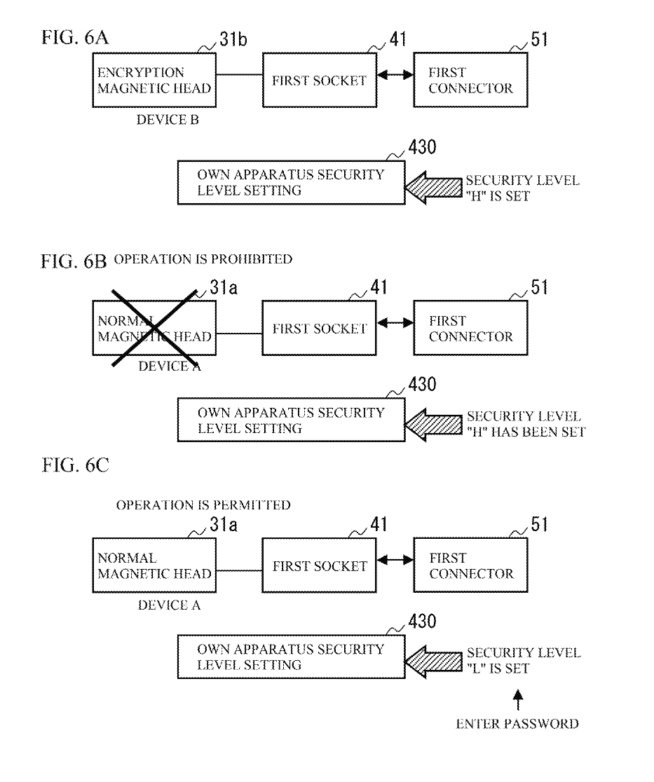

Next, with reference to FIG. 5 and FIGS. 6A-6C, a device connection setting process to be performed by the card reader 1 according to the embodiment of the present invention will be described. In the device connection setting process of the present embodiment, the encryption magnetic head 31b with a security level “H” (high) is electrically connected to the first connector 51. The IC contact block 32 with a security level “H” (high) is connected to the second connector 52. Nothing is connected in the third block. Based on these connections, an example will be described in which this encryption magnetic head 31b is replaced with the normal magnetic head 31a with a security level “L” (low). In the device connection setting process of the present embodiment, an example of entering a password as the identification operation will be described. The device connection setting process according to the embodiment of the present invention can be implemented by the control unit 10 developing in the RAM 11a and executing the control program stored in the ROM 11b of the storage unit 11. With reference to the flowchart of FIG. 5, the device connection setting process will be described in detail below in each step.

(Step S100)

First, the connector check unit 110 performs a connection detection process. The connector check unit 110 recognizes each device connected to the device I/F 17 at a time of activation and when the device is connected. That is, the connector check unit 110 checks a connector to which a socket is connected among the plurality of connectors. More specifically, by inspecting continuity of each connector, the connector check unit 110 inspects continuity of the first connector 51, the second connector 52, and the third connector 53 to which the device I/F 17 is connected. The connector check unit 110 stores information indicating the identified connectors in the storage unit 11 as the connector identification setting 400. That is, the connector check unit 110 stores a flag indicating presence of connection of the device I/F 17 to each connector in association with each connector.

The above-mentioned example of FIG. 4A indicates that the first socket 41 is connected to the first connector 51, and the second socket 42 is connected to the second connector 52, but the third socket 43 is not connected to the third connector 53.

(Step S101)

Next, the device discrimination unit 120 performs a previously connected device check process. The device discrimination unit 120 checks a device connected to each connector. More specifically, the device discrimination unit 120 reads the device connection setting 410 and checks the device connected to each connector at a time of previous end or before device exchange. Also, the device discrimination unit 120 sets the security levels corresponding to these devices in the own apparatus security level setting 430.

In the above-mentioned example of FIG. 4B, the encryption magnetic head 31b is connected to the first connector 51, and thus the security level is “H” (high). The IC contact block 32 is connected to the second connector 52, and thus the security level is “H” (high). The third socket 43 is not connected to the third connector 53, and thus the security level is set as a state where nothing is connected. In this example, the own apparatus security level setting 430 is set at “H” that is the lowest among the security levels of the connected devices. Note that in a case where the device of “L”, such as the normal magnetic head 31a, is connected before, the device discrimination unit 120 sets the own apparatus security level setting 430 at “L” (low).

(Step S102)

Next, the device discrimination unit 120 determines whether the own apparatus security level setting 430 is “H” (high). When Yes, that is, when the own apparatus security level setting 430 is “H” (high), the device discrimination unit 120 advances the process to step S103. When No, that is, when the own apparatus security level setting 430 is “L” (low), the device discrimination unit 120 advances the process to step S109.

(Step S103)

Next, the device discrimination unit 120 determines whether a corresponding device has been connected. The device discrimination unit 120 makes a communication via each connector and checks the connected device. For example, according to information referred to in step S101, the encryption magnetic head 31b is supposed to be connected to the first connector 51. Therefore, the device discrimination unit 120 makes a communication via the first connector 51 and determines whether a response arrives indicating reception from the encryption magnetic head 31b. When Yes, that is, when the response arrives, the device discrimination unit 120 determines that the encryption magnetic head 31b has been connected and advances the process to step S111. When No, that is, when the response fails to arrive, the device discrimination unit 120 determines that the normal magnetic head 31a has been connected and advances the process to next step S104.

(Step S104)

When the corresponding device is not connected although the own apparatus security level setting 430 is set at “H”, the device discrimination unit 120 performs a password acquisition process. The device discrimination unit 120 displays, for example, “Enter password” on the display unit and instructs a user who is a person in charge of maintenance or administrator to enter a password via the input unit. That is, in order to urge the user to switch connection, the device discrimination unit 120 causes the user to enter a predetermined password as an example of the identification operation. At this time, the device discrimination unit 120 sets an unillustrated timer and determines a timeout to be described below.

(Step S105)

Next, the device discrimination unit 120 determines whether the password is entered. When Yes, that is, when the correct password is entered, the device discrimination unit 120 advances the process to step S108. When No, that is, when the correct password is not entered yet, or when a wrong password is entered, the device discrimination unit 120 advances the process to next step S106.

(Step S106)

When the password is not entered, the device discrimination unit 120 determines whether a timeout occurs. When a specified time has elapsed after the device discrimination unit 120 starts waiting for password input, the device discrimination unit 120 determines Yes as a timeout. Otherwise, the device discrimination unit 120 determines No. When Yes, the device discrimination unit 120 advances the process to step S107. When No, the device discrimination unit 120 returns the process to step S104 and continues to wait for password input.

(Step S107)

When a timeout occurs, the device discrimination unit 120 performs an alarm process. The device discrimination unit 120 performs control to prohibit a device with a security level “L” detected by the connector check unit 110 from operating. Based on this control, the device discrimination unit 120 notifies a state in which the device is prohibited from operating, by issuing a warning from the warning unit, causing an alarm buzzer to sound, or turning on or blinking the LED. The device discrimination unit 120 also notifies the host apparatus 3. The host apparatus 3 may warn an unillustrated server of a monitoring institution or the like of fraud.

Accordingly, when the connector check unit 110 detects a device, the device discrimination unit 120 compares the security level corresponding to this detected device with the security level that is set in the own apparatus security level setting 430 in the storage unit 11. When the security level corresponding to this detected device is lower, the device discrimination unit 120 can perform control to prohibit the other device from operating. Note that when determined No in step S103, the device discrimination unit 120 can also perform control to prohibit the own apparatus from operating for the time being. Subsequently, the device discrimination unit 120 ends the device connection setting process.

(Step S108)

When the password is entered, the device discrimination unit 120 performs a connection switching process. In the above-mentioned example, since the security level of the normal magnetic head 31a is “L”, the device discrimination unit 120 performs the connection switching process. More specifically, the device discrimination unit 120 rewrites and sets the own apparatus security level setting 430 in the storage unit 11 at “L.” Moreover, in the above-mentioned example, the device discrimination unit 120 sets the device connection setting 410 such that the normal magnetic head 31a is connected to the first connector 51. The device discrimination unit 120 permits the own apparatus to operate. Subsequently, the device discrimination unit 120 ends the device connection setting process according to the embodiment of the present invention.

(Step S109)

When the own apparatus security level setting 430 is set at “L”, the device discrimination unit 120 determines whether a device with the security level “H” is connected. With reference to the device connection setting 410 in the storage unit 11, when a device with the security level “L” has been connected before even though a device with the security level “H” is actually connected, the device discrimination unit 120 determines Yes. That is, also here, for example, the device discrimination unit 120 makes a communication via the first connector 51 and determines whether a response arrives indicating reception from the encryption magnetic head 31b. That is, the device discrimination unit 120 determines Yes, when there is a response of communication from the encryption magnetic head 31b although the normal magnetic head 31a has been connected before. Otherwise, the device discrimination unit 120 determines No. When Yes, the device discrimination unit 120 advances the process to step S110. When No, the device discrimination unit 120 advances the process to step S111.

(Step S110)

When the device with the security level “H” is connected although the own apparatus security level setting 430 is set at “L”, the device discrimination unit 120 performs the connection switching process. Here, since the change from the security level “L” to the security level “H” is made, the device discrimination unit 120 changes each piece of information in the storage unit 11 without going through the identification operation described above. More specifically, the device discrimination unit 120 rewrites and sets the own apparatus security level setting 430 in the storage unit 11 at “H.” In the above-mentioned example, the device discrimination unit 120 sets the device connection setting 410 such that the encryption magnetic head 31b is connected to the first connector 51.

(Step S111)

Here, the device discrimination unit 120 performs a normal connection operation continuation process. The device discrimination unit 120 determines that each connected device is in a normal state and causes each device to operate in response to the control program in the storage unit 11. Subsequently, the device discrimination unit 120 ends the device connection setting process. Thus, the device discrimination unit 120 ends the device connection setting process according to the embodiment of the present invention.

### Example of Device Operation Control

Here, with reference to FIGS. 6A-6C, the following describes a specific operation example of controlling the device operation by the above-mentioned device connection setting process. This operation example will describe a configuration in which as a device group, one of the normal magnetic head 31a and the encryption magnetic head 31b can be connected to the control unit 10, which is a host device. As described above, it is detected that one of these devices has been connected, and the operation is controlled based on each connection order and state of connection. In the present embodiment, as described above, the security level corresponding to the normal magnetic head 31a is “L”, whereas the security level of the encryption magnetic head 31b is “H.” This is because the encryption magnetic head 31b has a higher defense level against a criminal.

First, in this example, as illustrated in FIG. 6A, the card reader is shipped to the market with the encryption magnetic head 31b attached to the control unit 10. In this case, the control unit 10 sets the security level of the security setting in the storage unit 11 at “H.”

Here, as illustrated in FIG. 6B, a factory, a service depot, a wholesale store, a retail store, or the like may connect the low-price normal magnetic head 31a again and ship the card reader, because it is necessary to exchange the encryption magnetic head 31b due to repair or specification change, or because whether the security level is high or low causes a difference in a device grade or price. In that case, the user removes the encryption magnetic head 31b and connects the normal magnetic head 31a to the control unit 10. Then, as described above, input of a password or the like is required as the identification operation. In this state, the own apparatus including the normal magnetic head 31a is not allowed to operate until the right password is acquired. This is to cope with a criminal or the like.

Meanwhile, as illustrated in FIG. 6C, when the identification operation such as password input is acquired, the control unit 10 confirms that the replacement procedure has been performed formally and allows the replacing normal magnetic head 31a to operate. That is, when the device with the high security level is replaced with the device with the low security level for a formal reason, the device is allowed to operate by the identification operation. Thus, by not changing all the operation automatically according to the connected device and switching the operation in a manual procedure as needed, both security and user's convenience can be achieved.

### Principal Effects of the Present Embodiment

The configuration as described above can produce the following effects. Conventionally, devices cannot be replaced arbitrarily because of a security problem. This is because, for example, when a criminal replaces a device with a device with the low security level and the device of the low security level operates as it is, the criminal can commit crime via the device with the low security level. That is, from a security viewpoint, it is important to detect a change of state from the high security level to the low security level. In other words, making it easy to change a state from the high security level to the low security level will result in easy decrease in security, which needs to be prevented.

Meanwhile, the card reader 1 according to the embodiment of the present invention is the card reader 1 that can connect a plurality of types of devices. The card reader 1 includes; the connector check unit 110 that detects connection of a new device; and the device discrimination unit 120 that calculates the security level of the new device detected by the connector check unit 110. In a case where the security level corresponding to the new device calculated by the device discrimination unit 120 is higher than the security level corresponding to the device connected before, the card reader 1 sets the security level in the nonvolatile memory. In a case where the connector check unit 110 detects another device, the card reader 1 compares the security level corresponding to the another device with the security level stored by a security recording unit in the nonvolatile memory. The card reader 1 performs control such that, when the security level is higher or identical, the card reader 1 allows the another device to operate, whereas when the security level is lower, the card reader 1 prohibits the another device from operating. Further, the card reader 1 according to the embodiment of the present invention includes the device discrimination unit 120 that acquires permission to operate from the user for another device that is prohibited by the device discrimination unit 120 from operating. In a case where the device discrimination unit 120 acquires the permission, the device discrimination unit 120 sets the security level corresponding to the another device in the nonvolatile memory.

Such a configuration can make it easy to perform downgrading, while making it easy to perform upgrading from a state where the security level is low to a state where the security level is high. Further, after the device with the high security level is replaced with the device with the low security level, acquiring only the permission to operate using a password for changing the device makes it possible to allow the device with the low security level to operate. That is, this configuration makes it possible to change the devices flexibly while maintaining security, by determining whether the security level is high or low, performing automatic updating from a low level to a high level, and performing processing according to a procedure only from a high level to a low level. This makes it possible to perform downgrading easily due to the user's environment, even after upgrading is once performed to the device with the high security level.

It is also possible, when a device is connected, to determine automatically whether the security level corresponding to the connected device is high or low and to perform control according to the device. As a result, even in a case where the device with the low security level operates normally when shipped and installed in the market and where the device with the high security level is subsequently purchased as a component and connected as upgrading, the control unit 10 can automatically determine that the device is replaced and allow the device to operate. In this case, when the control program for the replacing device is stored in the storage unit 11 in advance, the user does not particularly need to operate and can perform upgrading smoothly. Further, when one of the devices with the high security level is replaced with the device with the low security level, it becomes possible to allow only the device with the high security level to operate, and prohibit operation of the device with the low security level. As a result, the present embodiment can provide the card reader 1 that can maintain security although the card reader 1 allows device replacement.

In the card reader 1 according to the embodiment of the present invention, the plurality of types of devices includes the normal magnetic head 31a and the IC contact block 32. The device discrimination unit 120 sets the security level corresponding to the IC contact block 32 higher than the security level corresponding to the normal magnetic head 31a.

Such a configuring allows processing such as setting the security level high once the IC contact block 32 is connected, prohibiting the replacing normal magnetic head 31a from operating in this state, or allowing the normal magnetic head 31a to operate only when the operation is permitted by a password or the like. This allows the high security level corresponding to the IC contact block 32 to be maintained. That is, even if a criminal removes the IC contact block 32 and replaces it with the normal magnetic head 31a, the normal magnetic head 31a does not operate as it is. This allows prevention of an act such as skimming the customer's magnetic data from the normal magnetic head 31a with the low security level.

### Other Embodiments

The above-mentioned embodiment has described setting of the security level and control of operations in a case where one of the normal magnetic head 31a and the IC contact block 32 is connected and operates as a device group. However, at least an embodiment of the present invention is applicable to a device whose security level will be increased when the device is connected, by similar control. In addition, it is also possible to perform similar control on a device connected to another apparatus such as the host apparatus 3. That is, when the device with the high security level connected to the control unit 10 once makes a setting such that the security level becomes high, it is possible to prohibit the device with the low security level from operating, or to allow the device to operate after acquiring permission to operate.

The above-mentioned embodiment has described that, as a device group, the normal magnetic head 31a, the encryption magnetic head 31b, the IC contact block 32, and the noncontact type communication antenna 33 can be connected. However, in addition to the example described above, various types of other devices having different functions, performance, capability, and specifications can be connected. Also, the card reader 1 may include devices included in the basic configuration, and other “optional” devices to be additionally connected when the device configuration of the card reader 1 is changed through upgrading or the like. These other devices are selectively provided according to the configuration and grade of an ATM or the like and connected to the control unit 10. The user can also replace these devices. Therefore, the card reader 1 may include sockets and connectors other than the first to third sockets and connectors. Moreover, general interfaces such as USB and serial interface may be used for each socket and connector. Even in this case, it is preferred that the security level be set for each of the other devices.

For example, it is possible to support a case where a manually operated type card reader and an automatically operated type card reader include a common enclosure and the like, and where a device corresponding to the manually operated type card reader 1 that is not mounted is attached to the automatically operated type card reader.

Devices included in the device group are not limited to these devices and may include, for example, a secure magnetic head incorporating a processor for encryption, a biometrics device, a security camera, and a human sensor 15.

Notation indicating the security level may not be limited to “L” (low) and “H” (high) but may be indicated numerically, for example. In addition to “high” and “low”, for example, several steps of values may be set. For example, a security level of “higher” than the normal “high” may be set for devices such as a secure magnetic head, a biometrics device, a security camera, and a human sensor. Also, the security level may be uniformly set by a grade or configuration of the card reader 1, or may differ for each device. This makes it possible to easily change the configuration of various devices while keeping the security level, thereby reducing costs.

The above-mentioned embodiment has described an example of issuing a warning when the device with the high security level is connected and then the device with the low security level is connected. However, the card reader 1 may be configured, when the device with the high security level that is supposed to be connected is not actually connected, to not start the operation of the card reader 1 itself or to issue an alarm. Such a configuration allows the card reader 1, when a criminal removes only the device with the high security level, to issue a warning, thereby increasing security. Note that even in such a case, it is preferred that, when the device with the high security level is once connected, connection of the device be set in the device connection setting 410 of the storage unit 11. Accordingly, effects of making it difficult for a criminal to make modifications can be expected.

The above-mentioned embodiment has described password input as an example of permission to operate by the identification operation; however, permission to operate may be acquired by another method. For example, depending on a type and characteristic of a device, a special procedure may be required, such as operating a physical wire or physical key, operating a switch, and changing identification (ID) or key data. Such a configuration can improve security.

It is needless to say that the configuration and operation of the above-described embodiments are illustration and can be appropriately changed and executed without departing from the spirit of the present invention.

While the description above refers to particular embodiments of the present invention, it will be understood that many modifications may be made without departing from the spirit thereof. The accompanying claims are intended to cover such modifications as would fall within the true scope and spirit of the present invention.

The precisely disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A card reader for connecting a plurality of types of devices detachably, the card reader comprising:
a connection detection unit configured to check a connector to which a socket is connected among connectors of the plurality of types of devices;
a device discrimination unit configured to check information stored in association with the connector checked by the connection detection unit and to set a security level of an own apparatus; and
a data-processing unit configured to record or reproduce data in a card corresponding to the security level of the own apparatus that is set by the device discrimination unit.

2. The card reader according to claim 1, wherein the device discrimination unit is configured to:
check the information regarding the security level that is set corresponding to the device detected by the connection detection unit;
set the security level of the own apparatus during operation high in a case where the security level corresponding to the checked device is higher than the security level corresponding to the device connected before; and
prohibit the own apparatus from operating unless an identification operation is performed in a case where the security level corresponding to the checked device is lower than the security level corresponding to the device connected before.

3. The card reader according to claim 2, wherein the device discrimination unit is configured to:
acquire permission to operate from a user as the identification operation; and
set the security level of the own apparatus during operation high in a case where the permission to operate is acquired.

4. The card reader according to claim 1, wherein
the plurality of types of devices comprises a normal magnetic head, an encryption magnetic head, an IC contact block, and a noncontact type communication antenna, and
the connector comprises a first connector to which one of the socket for the normal magnetic head and the socket for the encryption magnetic head is connectable, a second connector to which the IC contact block is connectable, and a third connector to which the noncontact type communication antenna is connectable.

5. The card reader according to claim 4, wherein the security levels corresponding to the encryption magnetic head, the IC contact block, and the noncontact type communication antenna are higher than the security level corresponding to the normal magnetic head.

6. The card reader according to claim 2, wherein
the plurality of types of devices comprises a normal magnetic head, an encryption magnetic head, an IC contact block, and a noncontact type communication antenna, and
the connector comprises a first connector to which one of the socket for the normal magnetic head and the socket for the encryption magnetic head is connectable, a second connector to which the IC contact block is connectable, and a third connector to which the noncontact type communication antenna is connectable.

7. The card reader according to claim 6, wherein the security levels corresponding to the encryption magnetic head, the IC contact block, and the noncontact type communication antenna are higher than the security level corresponding to the normal magnetic head.

8. The card reader according to claim 3, wherein
the plurality of types of devices comprises a normal magnetic head, an encryption magnetic head, an IC contact block, and a noncontact type communication antenna, and
the connector comprises a first connector to which one of the socket for the normal magnetic head and the socket for the encryption magnetic head is connectable, a second connector to which the IC contact block is connectable, and a third connector to which the noncontact type communication antenna is connectable.

9. The card reader according to claim 8, wherein the security levels corresponding to the encryption magnetic head, the IC contact block, and the noncontact type communication antenna are higher than the security level corresponding to the normal magnetic head.

10. A method of controlling a card reader to be executed by the card reader for connecting a plurality of types of devices detachably, the method comprising:
checking a connector to which a socket is connected among connectors of the plurality of types of devices; and
checking information stored in association with the checked connector; and
setting a security level of an own apparatus.
